(19) United States
(12) Patent Application Publication
(10) Pub. No.: US 2008/0005238 A1
(43) Pub. Date: Jan. 3, 2008

(54) Roaming consistent user representation information across devices and applications

(75) Inventors: Martin J. Hall, Seattle, WA (US); Allison O'Mahony, Redmond, WA (US); Darwin K. Yamamoto, Seattle, WA (US); Jason C. Fluegel, Seattle, WA (US); Michael C. Kunz, Seattle, WA (US); Tammy L. Savage, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/478,250

(22) Filed: Jun. 29, 2006

(51) Int. Cl. G06F 15/16

(52) U.S. Cl. 709/204

(57) ABSTRACT

The techniques and technologies described herein enable real-time user identity information to be maintained by a network server architecture such that the user identity information can be provided across multiple client devices and/or across multiple collaborative applications supported by the client devices. The client devices and the collaborative applications can be designed to receive and process the network-based user identity information for presentation in a consistent display format regardless of the client device type and in the context of different collaborative applications.

### BACKGROUND

Computer systems and software applications may be designed to handle the presentation of user identity information in connection with collaborative user applications. Such user identity information has traditionally been stored and maintained at the end user computer devices. Collaborative communication systems, video game systems, and other collaborative applications enable users to communicate or interact with one another in real-time. Such collaborative applications include instant messaging applications, software-based telephone systems, interactive video game systems, and other applications deployed over a network. The concepts of user presence, user identity information, user status, or the availability of an individual to communicate can be key components of such real-time communication applications. For example, user presence is often displayed by the computer system hosting the collaborative communication application. For example, an instant messaging application may generate a display of a list of users along with their respective presence status, e.g., “online,” “available,” “offline,” “do not disturb,” “out of the office,” or the like. Such user presence information may include the real-time status of the local user of the host computer system, along with the real-time status of one or more additional users of the instant messaging application (e.g., persons in the local user's contacts list or address book). The local user can manipulate the graphical user interface of the instant messaging application to change his or her current presence status in real-time, and the updated presence status will be visible by other users of the instant messaging application. As another example, avatars, pictures, or graphics are often utilized as a way to display a person's identity to others in a network community.

In a conventional operating environment, the display logic and user identity information are maintained by the client devices themselves. Thus, the appearance, configuration, and layout of user identity information as displayed on a conventional host device can vary from one device to another device, even if the user identity information is displayed in connection with the same collaborative application. Moreover, the appearance, configuration, and layout of user identity information as displayed on a conventional host device can vary depending upon the specific collaborative application running on the host device. Indeed, a single user may have one real-time status for one application running on the host device and another, potentially different, real-time status for another application running on the host device.

### BRIEF SUMMARY

The techniques and technologies described herein can be utilized to provide consistently displayed user representation information (which may include presence information, a status message, and a user avatar or picture) across different client devices and/or across different client applications. The same real-time user identity information can be displayed in a consistent manner across client devices and client applications by providing remote network access to the identity information. Compatible client devices and/or collaborative applications include a suitably configured graphical user interface control that processes the real-time user identity information for consistent rendering on the client devices.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of an example embodiment may be derived by referring to the detailed description and claims when considered in conjunction with the following figures, wherein like reference numbers refer to similar elements throughout the figures.

FIG. 1 is a schematic representation of a network environment for implementing an example embodiment;

FIG. 2 is a simplified schematic representation of an example computing device for implementing an example embodiment of a client device or a server device;

FIG. 3 is a simplified schematic representation of an example client device;

FIG. 4 is a simplified schematic representation of an example network server architecture;

FIG. 5 is a schematic representation of a network server architecture supporting two client devices;

FIG. 6 is a screen shot of an example graphical representation of real-time identity information as displayed in connection with an application;

FIG. 7 is a screen shot of an example graphical representation of real-time identity information;

FIG. 8 is a screen shot that depicts a dropdown menu feature of the graphical representation of real-time identity information shown in FIG. 7;

FIG. 9 is a screen shot of another example graphical representation of real-time identity information;

FIG. 10 is a flow chart of an example process for roaming user representation information in the context of two client devices; and

FIG. 11 is a flow chart of an example process for roaming user representation information in the context of two collaborative applications.

### DETAILED DESCRIPTION

The following detailed description is merely illustrative in nature and is not intended to limit the embodiments described herein or the application and uses of such embodiments.

Example embodiments may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that practical embodiments may be practiced in conjunction with any number of data transmission protocols and that the system described herein is merely one example embodiment.

For the sake of brevity, conventional techniques related to computer devices, collaborative communication applications, data transmission, network control, computer operating systems, graphical user interface controls, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an example embodiment.

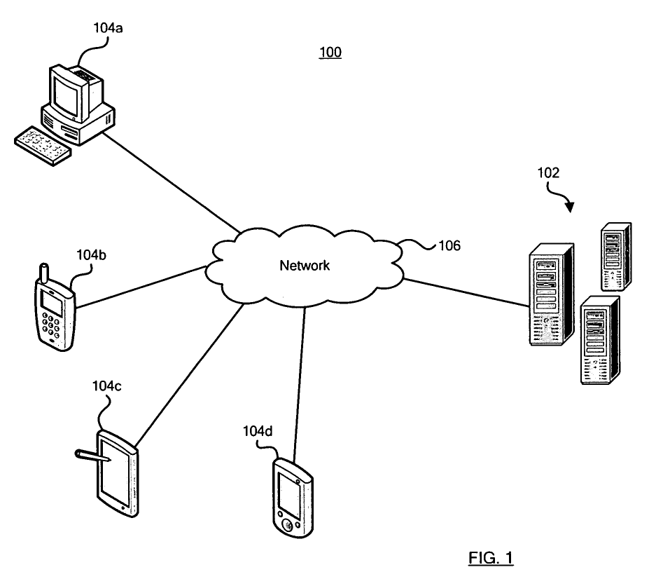

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematics shown in FIGS. 1-5 depict example arrangements of elements, additional or fewer elements, devices, features, or components may be present in an example embodiment (assuming that the functionality of the described system is not adversely affected).

FIG. 1 is a schematic representation of a network environment 100 for implementing an example embodiment as described herein. Network environment 100 may include a suitably configured network server architecture 102 and one or more client devices 104 configured to communicate with network server architecture 102 via a data communication network 106. Network environment 100 and the techniques and technologies described herein enable users of client devices 104 to understand how they are being graphically displayed across a potentially broad universe of applications and experiences. The graphical representation of user identity or presence acts as a “mirror” of the user's currently projected and displayed status throughout a collaborative environment and possibly throughout an entire suite of products and services. A suitably configured graphical user interface (“GUI”) control for a client device 104 allows the user to publish real-time status information for use by others in network environment 100. In this regard, a user can maintain his or her identity and current presence status in a system that is separated from the client device hardware and software.

As used herein, “user identity information” is data or information associated with a user's name, appearance, personality, presence, status, activity, location, etc., particularly with respect to an application running on one or more client devices. One person may have more than one identity (for example, corresponding to multiple network usernames) and, therefore, more than one set of user identity information. Such user identity information can be utilized to populate a graphical element that is rendered in connection with one or more applications running on a client device. For example, user identity information may include, without limitation: a display name; a personal status or activity message; a display image, picture, or avatar; a real-time user presence or status indicator; and/or other information related to the user. In the example embodiments described herein, the remote network storage of the real-time user identity information allows a user to roam from application to application, location to location, machine to machine, and device to device, while preserving a consistently displayed user representation. In example embodiments, network updating of user identity information and client device processing of user identity information can be achieved without the use of peer-to-peer technologies.

Server architecture 102 may include one or more computing devices having the processing logic and functional capacities described in more detail below. Briefly, server architecture 102 maintains user identity information, manages access to the user identity information by client devices 104, and communicates with user devices 104 to update the user identity information in real-time. The operation of an example server architecture 102 is described in more detail below.

Data communication network 106 may utilize any suitable data communication, telecommunication, wireless, wired/cabled, or other technology. In practical deployments, data communication network 106 can be realized using any number of devices, systems, or components, and data communication network 106 may utilize any number of communication links. For example, data communication network 106 may include or be realized as a LAN, a WAN, a WLAN, the Internet, a cellular service network, a paging service network, a PBX, or the like. In practice, network server architecture 102 may be coupled to data communication network 106 using any suitable communication link, which may be a wired link, a wireless link, or a link that combines wired and wireless technologies. Each client device 104 may also be coupled to data communication network 106 using a wired communication link, a wireless communication link, or a communication link that combines wired and wireless technologies.

Each client device 104 may be a computing device having a particular configuration and platform, and each client device 104 can host one or more collaborative applications having real-time features. For example, network environment 100 may include, without limitation, any number of the following client devices 104: a personal computer 104a; a mobile telephone 104b; a portable computer 104c, such as a personal digital assistant, a pocket personal computer, a tablet computer, or a laptop computer; a video game device, such as a portable video game device or a video game console; or the like. The particular physical configuration of a client device 104, the applications hosted by a client device 104, and the manner in which a client device 104 communicates with network server architecture 102 can be selected to suit the needs of the individual user and/or to accommodate the particular system deployment. A client device 104 is generally configured to access or receive real-time user identity information maintained by network server architecture 102, process that information, and present that information for a collaborative application of the client device 104. The information may be presented by generating a graphical representation of the information for rendering at the client device 104. In example embodiments, the presentation of the user identity information is performed in a consistent manner across different applications and across different client device types. The operation of an example client device 104 is described in more detail below.

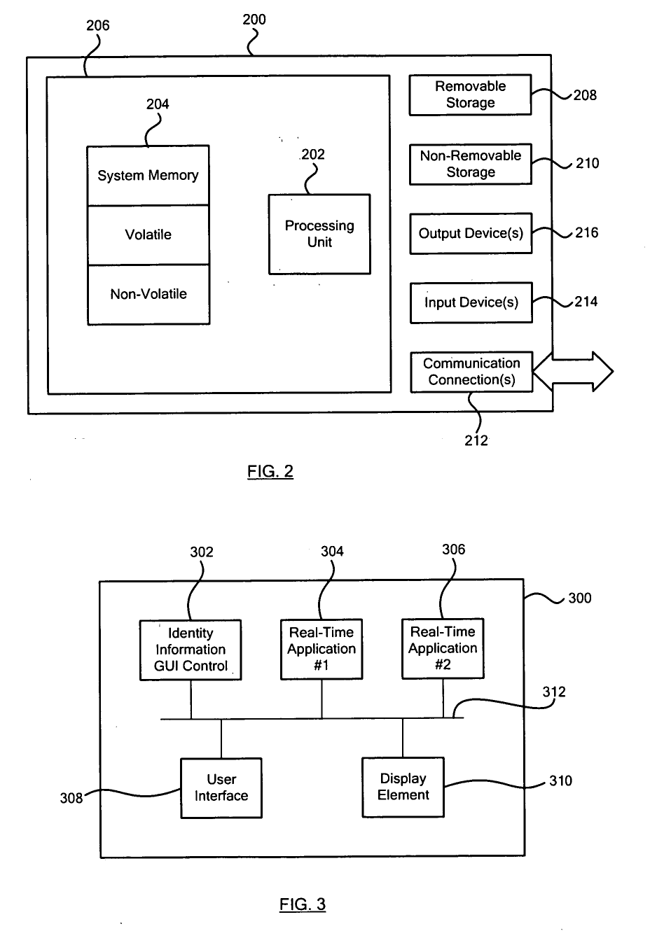

FIG. 2 is a simplified schematic representation of an example computing device 200 for implementing an example embodiment of a client device or a server device. Referring to FIG. 1, one or more devices having the arrangement and general operating characteristics of computing device 200 may be utilized in connection with network server architecture 102, and a device having the arrangement and general operating characteristics of computing device 200 may be utilized for any client device 104. Computing device 200 is only one example of a suitable operating environment and it is not intended to suggest any limitation as to the scope of use or functionality of any practical embodiment. Other well known computing systems, environments, and/or configurations that may be suitable for use include, but are not limited to, personal computers, server computers, hand-held or laptop devices, personal digital assistants, mobile telephones, multiprocessor systems, microprocessor-based systems, programmable consumer electronics, network PCs, minicomputers, mainframe computers, distributed computing environments that include any of the above systems or devices, and the like.

Computing device 200 and certain aspects of the example embodiments may be described in the general context of computer-executable instructions, such as program modules, executed by one or more computers or other devices. Generally, program modules include routines, programs, objects, components, data structures, and/or other elements that perform particular tasks or implement particular abstract data types. Typically, the functionality of the program modules may be combined or distributed as desired in various embodiments.

Computing device 200 typically includes at least some form of computer readable media. Computer readable media can be any available media that can be accessed by computing device 200 and/or by applications executed by computing device 200. By way of example, and not limitation, computer readable media may comprise computer storage media and communication media. Computer storage media includes volatile, nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 200. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Referring again to FIG. 2, in its most basic configuration, computing device 200 typically includes at least one processing unit 202 and a suitable amount of memory 204. Depending on the exact configuration and type of computing device 200, memory 204 may be volatile (such as RAM), non-volatile (such as ROM, flash memory, etc.) or some combination of the two. This most basic configuration is identified in FIG. 2 by reference number 206. Additionally, computing device 200 may also have additional features/functionality. For example, computing device 200 may also include additional storage (removable and/or non-removable) including, but not limited to, magnetic or optical disks or tape. Such additional storage is illustrated in FIG. 2 by removable storage 208 and non-removable storage 210. Memory 204, removable storage 208, and non-removable storage 210 are all examples of computer storage media as defined above.

Depending upon the particular embodiment, processing unit 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

The steps of a method or algorithm described in connection with the embodiments disclosed herein may be embodied in hardware, in firmware, in a software module executed by a processor, or in any practical combination thereof. A software module may reside in RAM memory, flash memory, ROM memory, EPROM memory, EEPROM memory, registers, a hard disk, a removable disk, a CD-ROM, or any other form of storage medium known in the art. In this regard, memory 204 can be coupled to processing unit 202 such that processing unit 202 can read information from, and write information to, memory 204. In the alternative, memory 204 may be integral to processing unit 202. As an example, processing unit 202 and memory 204 may reside in an ASIC.

Computing device 200 may also contain communications connection(s) 212 that allow the system to communicate with other devices. Communications connection(s) 212 may be associated with the handling of communication media as defined above. As explained in more detail below, communication connection(s) 212 may be utilized to facilitate the exchange of user presence information, real-time user identity information, update data indicative of a change in current user identity status, and/or other data, information, or signals between computing device 200 and a data communication network.

Computing device 200 may also include or communicate with input device(s) 214 such as a keyboard, a mouse or other cursor pointing device, a pen, a voice input device, a touch input device, a webcam device, a microphone, etc. Although the example embodiment described herein utilizes a mouse device, embodiments can be equivalently configured to support a trackball device, a joystick device, a touchpad device, or any type of general purpose pointing device. Computing device 200 may also include or communicate with output device(s) 216 such as a display monitor, speakers, a printer, or the like. All of these devices are well known in the art and need not be discussed at length here.

FIG. 3 is a simplified schematic representation of an example client device 300, which may be deployed in network environment 100 as any one of the client devices 104 (see FIG. 1). Client device 300 may be realized using the general arrangement described above for computing device 200; for the sake of simplicity and brevity, FIG. 3 does not redundantly depict the elements shown in FIG. 2. Client device 300 generally includes an identity information GUI control 302, a first real-time collaborative application 304, a second real-time collaborative application 306, a user interface 308, and a display element 310. Some or all of these elements may be coupled together using a bus 312 or any suitable interconnection architecture, technique, or technology.

For this example embodiment, first real-time collaborative application 304 and second real-time collaborative application 306 are two different applications installed on, hosted by, or deployed on client device 300. In this regard, a real-time collaborative communication application may be installed on client device 300, or it may be accessed remotely by client device 300 for purposes of virtual presentation to the user of client device 300. In this example, the current user of client device 300 is considered the “first person” user of a collaborative application, and “third person” users of a collaborative application are potentially able to communicate or otherwise interact in real-time with the first person user. Such real-time interaction may be carried out using any suitable technologies, techniques, or protocols. In practice, a collaborative application may be an instant messaging application, an email application, a telecommunication application, a calendar application, a scheduling application, an interactive video game application, an online chat room application, an online marketplace, a shared or personal blog/website/webspace, an online review system, or the like.

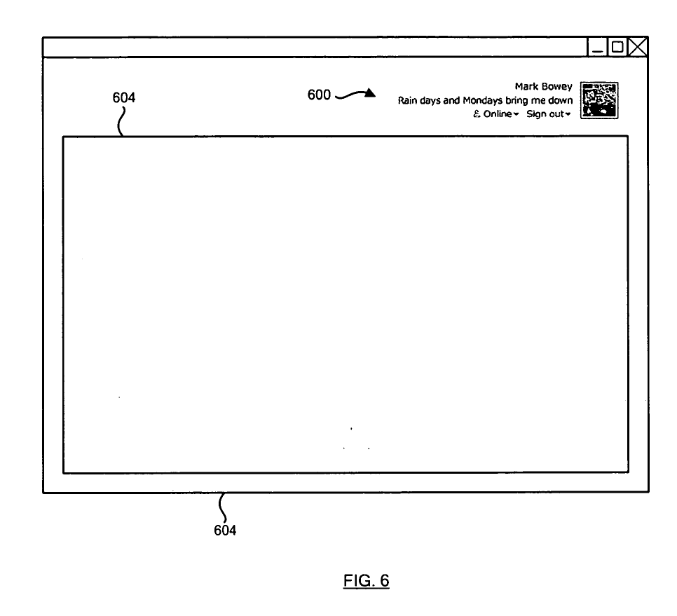

In connection with the operation of first real-time collaborative application 304, client device 300 can generate a first graphical representation of real-time user identity information for rendering on display element 310. Examples of such graphical displays are described below with reference to FIGS. 6-9. The particular configuration, format, size, shape, and contents of the first graphical representation may be influenced by the native graphical processing and display capabilities of client device 300 and/or by the functionality of first real-time collaborative application 304. Similarly, in connection with the operation of second real-time collaborative application 306, client device 300 can generate a second graphical representation of real-time user identity information for rendering on display element 310. The particular configuration, format, size, shape, and contents of the second graphical representation may also be influenced by the native graphical processing and display capabilities of client device 300 and/or by the functionality of second real-time collaborative application 306. In example embodiments, the first graphical representation and the second graphical representation are similar or identical, thus providing a consistent indication of the user's current identity and/or presence status that can roam across the two collaborative applications. Although client device 300 is depicted with only two collaborative applications, an embodiment of client device 300 can support any number of collaborative applications and any number of corresponding graphical representations of the same user identity information.

The collaborative applications supported by client device 300 may receive, manage, process, or otherwise handle real-time user identity information for users of the collaborative applications. The user identity information may be updated in response to changes in user availability status, in response to user interaction with the collaborative applications and/or with the graphical representations of the user identity information, or in response to other criteria. For example, the user identity information may include user presence information that indicates whether a given user of a collaborative application is currently: available; unavailable; online; offline; on vacation; out of the office; in a meeting; etc. The number of different user presence status types and the specific labels or descriptors for the user presence status types may be determined by the particular collaborative application. In one example embodiment, user presence information is shared by multiple applications such that a change in user status initiated by collaborative application 304 is reflected in collaborative application 306. Such an embodiment ensures a consistent user presence status across multiple platforms and domains.

Identity information GUI control 302 is a logical element that may be incorporated into the operating system of client device 300. In alternate embodiments, identity information GUI control 302 may be incorporated into first real-time collaborative application 304 and/or into second real-time collaborative application 306. Identity information GUI control 302 is suitably configured to obtain user identity information and process that information in a manner that results in a graphical representation of the information on client device 300. In practice, the user identity information may be processed differently depending upon the client device type (e.g., personal computer, cellular telephone, video game console) and depending upon the functionality of the collaborative application (e.g., email, instant messenger, chat room, video game). In this example, collaborative application 304 and collaborative application 306 may be configured to accommodate the graphical element controlled by identity information GUI control 302. In other words, collaborative application 304 and collaborative application 306 may reserve some GUI space for a respective graphical element such that identity information GUI control 302 can populate the graphical elements.

User interface 308 may be suitably configured to enable the user of client device 300 to interact with the real-time collaborative applications and the graphical representations of the user identity information. In example embodiments, user interface 308 may include a keyboard, a cursor pointing device, and/or any of the input devices 214 mentioned above (see FIG. 2). For portable or mobile devices, user interface 308 may be scaled down (in size and/or in features) in a suitable manner. Display element 310 may be suitably configured in accordance with the particular platform and form factor of client device 300. Conventional aspects of user interface 308 and display element 310 will not be described herein.

FIG. 4 is a simplified schematic representation of an example network server architecture 400 suitable for use in network environment 100. Network server architecture 400 may be realized using the general arrangement described above for computing device 200; for the sake of simplicity and brevity, FIG. 4 does not redundantly depict the elements shown in FIG. 2. In practice, network server architecture 400 may be realized using any number of physical devices or machines, and the processing logic implemented by network server architecture 400 can be distributed throughout multiple processing units. Network server architecture 400 generally includes a user authentication module 402, a communication interface 404, and an identity information manager 406. Network server architecture 400 may also include or communicate with a suitably configured memory element 408 or database that maintains user identity information as discussed herein. Some or all of these elements may be coupled together using a bus 410 or any suitable interconnection architecture, technique, or technology.

Memory element 408 is configured and controlled to maintain real-time user identity information for users of a service that supports at least one collaborative application that can be hosted by client devices that communicate with network server architecture 400. In this context, the service may be a network-based service that enables users to log in or authenticate themselves for access to certain features, benefits, applications, data, etc., which may be provided by the service. For example, the service may be related to one or more of the following, without limitation: an online communication community; an online interactive video game environment; a real-time instant messaging application; an Internet service provider or portal that gives access to multiple applications, features, or services to authenticated users; or any network-based community driven application. Network server architecture 400 is suitably configured to create, maintain, and update the user identity information in memory element 408 such that real-time changes to the user identity information are made available to any number of users of the service. In practice, memory element 408 may include a list of authorized users of the service, and corresponding data fields for the identity information for each authorized user. Centralized maintenance of the user identity information in this manner makes it easy for a system embodiment to roam a consistent graphical representation of each user's identity information across different device platforms and/or across different client applications.

Network server architecture 400 may include an identity information manager 406 that manages, controls, and processes the current user identity information for the users of the network service and/or for the users of the various client-based collaborative applications. In example embodiments, identity information manager 406 represents processing logic that facilitates updating of the user identity information. In addition, identity information manager 406 may be configured to manage and provide access to the real-time user identity information to at least one client device for graphical rendering of the real-time user identity information in the context of at least one collaborative application hosted by the at least one client device. Thus, identity information manager 406 may be responsible for handling the creation of new user identity information, updating existing user identity information, and deleting user identity information. Moreover, identity information manager 406 may be responsible for other data management, control, and configuration functions described herein.

Communication interface 404 is configured to communicate with one or more remote computing devices, such as client devices 104 (see FIG. 1). Communication interface 404 enables network server architecture 400 to transmit real-time user identity information to the client device(s) for native processing and graphical display rendering by the client device(s). If the user identity information is displayed on web pages, then network server architecture 400 transmits suitably formatted HTML documents to the client device(s). Accordingly, communication interface 404 may include hardware, software, and/or firmware that is suitably configured to be compliant with the particular data communication scheme or schemes supported by network server architecture 400. In this regard, communication interface 404 may be designed to be compliant with one or more data communication techniques, technologies, standards, specifications, or protocols, including, without limitation: wired USB technology; wireless USB technology; BLUETOOTH wireless technology; IEEE 802.11 wireless technology (any variation); Ethernet networking protocols; RF; IrDA (infrared); ZigBee (and other variants of the IEEE 802.15 protocol); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; hospital or health care facility network protocols, which may be wired or wireless such as those operating in the WMTS bands; GPRS; home network communication protocols; and IEEE 1394 (Firewire).

User authentication module 402, which may be realized as hardware, software, and/or firmware, is suitably configured to manage user authentication to the service or services provided or facilitated by network server architecture 400. User authentication module 402 may also be configured to manage user authentication to individual applications provided or facilitated by network service architecture 400. In example embodiments, user authentication module 402 may be incorporated into a general security module, which performs any number of the following functions, without limitation: establishment of secure communication channels with network server architecture 400; management of usernames and passwords; data encryption/decryption; or the like.

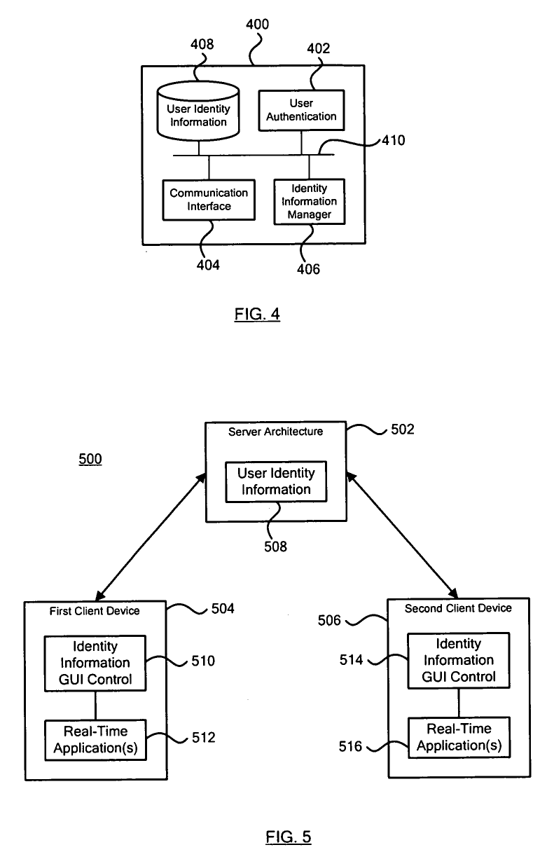

FIG. 5 is a schematic representation of an operating environment 500 wherein a network server architecture supports two different client devices. Environment 500 represents a simple deployment where a network server architecture 502 communicates with a first client device 504 and a second client device 506. The client devices may (but need not) be different device types that use different device platforms and/or different device form factors. For example, in an office network deployment, both client devices may be realized with the same model of a desktop personal computer. Alternatively, first client device 504 may be the user's office computer, while second client device 506 may be the user's PDA. Network server architecture 502 may be configured as described above for network server architecture 400, and each of the client devices may be configured as described above for client device 300; common features and functions will not be redundantly described here in the context of FIG. 5.

Network server architecture 502 maintains user identity information 508, which is accessible to both client devices. This example assumes that the same user identity (typically corresponding to one username and one password) is able to access network server architecture 502 from both client devices. Thus, the same user identity information 508 for this particular user can be shared by both client devices, whether or not the user is concurrently using both client devices.

In this example, first client device 504 includes an identity information GUI control 510 (as described above for client device 300) and at least one real-time collaborative application 512. The application 512 cooperates with identity information GUI control 510 to obtain user identity information 508 from network server architecture 502, and to present a graphical representation of user identity information 508 at first client device 504. As mentioned above, identity information GUI control 510 is configured in accordance with the specific hardware, software, firmware, and/or operating characteristics of first client device 504. In this example, second client device 506 includes an identity information GUI control 514 and at least one real-time collaborative application 516. The application 516, which may or may not provide the same functionality as application 512, cooperates with identity information GUI control 514 to obtain user identity information 508 from network server architecture 502, and to present a graphical representation of the same user identity information 508 at second client device 506. In this example embodiment, the displayed characteristics, format, and appearance of user identity information 508 are identical (or nearly identical) on both client devices. In other words, the display of user identity information 508 consistently appears on both client devices. This provides an association of the user's experience with a single displayed identity and status, and a consistent representation of the user's self that can be separated from any particular computing device.

The graphical representation of the user identity information can be displayed in any desired location on a client device in the context of an application running on that client device. This graphical representation may be provided in an “identity area” on the display element of the client device. In one example embodiment, the identity area is displayed throughout the user experience (i.e., regardless of the application or applications that are currently running, and regardless of the content that is currently displayed on the client device) as long as the user remains logged in to the service. For example, the identity area may be displayed in a corner of each page or screen, thus providing the user with a “mirror image” of how she is being represented to others across the network service. FIG. 6 is a screen shot of an example identity area 600 as displayed in connection with an application for a client device. FIG. 6 depicts the overall display area 602 of the client device with identity area 600 concurrently displayed in the display area 602. In this example, most of display area 602 is utilized as application display space 604. Application display space 604 corresponds to the primary application or applications with which identity area 600 is displayed. For example, application display space 604 may include display elements related to an email application, web browser content, a calendar, or the like.

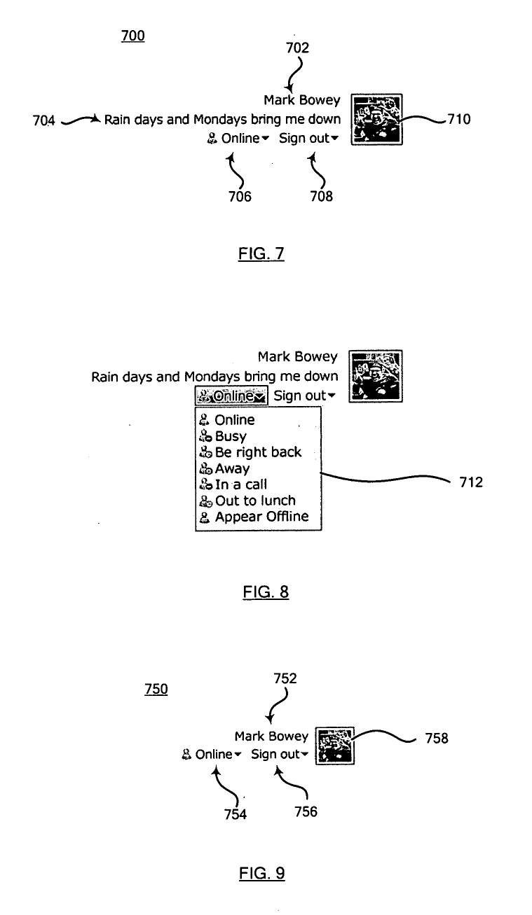

FIG. 7 is a screen shot of an example identity area 700, which includes a graphical representation of real-time identity information for a user. The content of identity area 700 may be determined or influenced by the service provider, by user preferences, by the collaborative application, or the like. In this example, identity area 700 includes a display name 702, a personal message 704, a presence status indicator 706, a sign in/out control 708, and a display image 710. Identity area 700 is suitable for use with a client device having a relatively large display element, e.g., a laptop display, a desktop monitor, or the like. As an example of possible scaling for identity area 700, display image 710 may be about 40×40 pixels in size.

Display name 702 can be any character string that identifies the user identity. If the user has not yet established a display name, then the field for display name 702 may be left blank or it may be populated with a prompt such as “Add Your Name.” The prompt may be realized as an active link that enables the user to enter a display name character string via an inline text entry field. An inline text entry field may also be utilized to enable editing of display name 702. As mentioned above, the user-entered data is transferred to the network server architecture for storage and maintenance.

Personal message 704 can be any character string that can be entered and edited by the user. Identity area 700 may be configured to display different personal messages corresponding to different user presence status. For example, if the status of the user is “Busy,” then personal message 704 may read “Please try again later,” and if the status of the user is “On Vacation,” then personal message 704 may read “Wish you were here.” If the user has not yet established a personal message, then the field for personal message 704 may be left blank or it may be populated with a prompt such as “Type Your Personal Message.” The prompt may be realized as an active link that enables the user to enter a character string via an inline text entry field. An inline text entry field may also be utilized to enable editing of personal message 704. As mentioned above, the user-entered data is transferred to the network server architecture for storage and maintenance.

Personal message 704 (or another field in identity area 700) may include dynamic user status information that corresponds to a dynamic condition or state of the client device. For example, the dynamic status information may indicate the title of a song, movie, or video clip that is currently being played (or one that has been recently played), it may indicate the name of a web page that is currently being viewed (or one that has been recently viewed), or the like.

Presence status indicator 706 displays the current real-time status of the user, as maintained by the network server architecture. For example, presence status indicator 706 may indicate that the user is currently online as depicted in FIG. 7. The number of different user presence status types and the specific labels or descriptors for the user presence status types may vary from one implementation to another. In one embodiment, the following user presence status identifiers can be displayed: online; busy; be right back; away; in a call; out to lunch; and appear offline. Of course, alternative, fewer, or additional user presence status indicators may be used in connection with an embodiment of identity area 700. Presence status indicator 706 may include a dropdown menu feature that allows the user to quickly select different options by manipulating identity area 700. In this regard, FIG. 8 is a screen shot that depicts an example dropdown menu 712 for identity area 700. Different menus can be displayed for dropdown menu 712 depending upon the current user status. For example, dropdown menu 712 as depicted in FIG. 8 represents one example where the user has already activated an instant messaging application. Thus, the entries in dropdown menu 712 include an option that allows the user to “Sign Out Of Messenger” (i.e., the user can deactivate the instant messaging application while remaining logged on to the network service). If, on the other hand, the user has not yet activated the instant messaging application, the dropdown menu associated with presence status indicator 706 may include an option that allows the user to “Start Messenger.” As mentioned above, changes to the real-time user presence status can be transferred to the network server architecture for storage and maintenance.

Sign in/out control 708 may be realized as a dropdown menu and/or an active link that allows the user to sign in/out of the network service. Sign in/out control 708 depicted in FIG. 7 assumes that that user is currently signed in to the network service. Accordingly, sign in/out control 708 provides the option to sign out (sign in/out control 708 may also give the user the option to change identities and the option to remove identities). If, however, the user is currently signed out of the network service, sign in/out control 708 provides the option to sign in. In one example embodiment, if the user is signed out of the network service, then identity area 700 is configured such that only a “Sign In” active link is displayed to the user. Sign in/out control 708 allows a single person to sign in and out of a given account using, for example, a unique username and password combination. In other words, a single person can sign in as different online entities or identities.

Display image 710 may include a picture of the user, an avatar, or any graphic. Different display images may be displayed, depending upon the current user presence status. In one example embodiment, the user is allowed to add, select, or change the display image 710, using a menu, a link, or any suitable control mechanism for identity area 700. As mentioned above, changes to display image 710 can be transferred to the network server architecture for storage and maintenance.

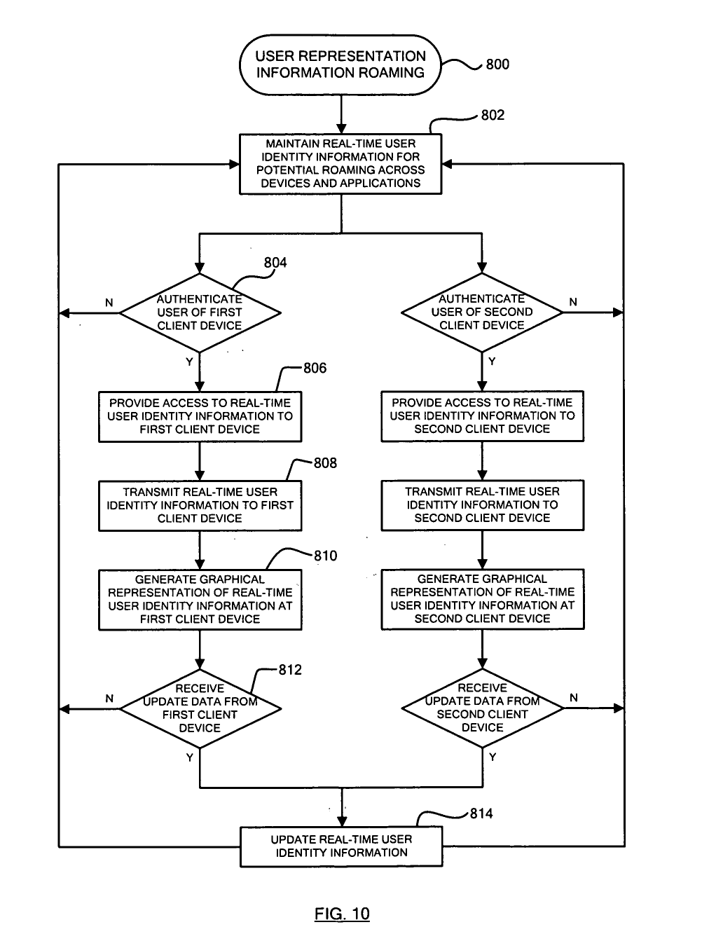

FIG. 9 is a screen shot of another example identity area 750, which includes a graphical representation of real-time identity information for a user. Identity area 750 shares some elements with identity area 700; common features will not be redundantly described in the context of identity area 750. In this example, identity area 750 includes a display name 752, a presence status indicator 754, a sign in/out control 756, and a display image 758. Identity area 750 represents a scaled-down version of identity area 700. Such a scaled-down version may be desirable for rendering on a compact client device, e.g., a cellular telephone, a PDA, a portable video game device, or the like. Notably, identity area 750 need not include a third display line for a personal message as described above for identity area 700. As an example of possible scaling for identity area 750, display image 758 may be about 28×28 pixels in size.

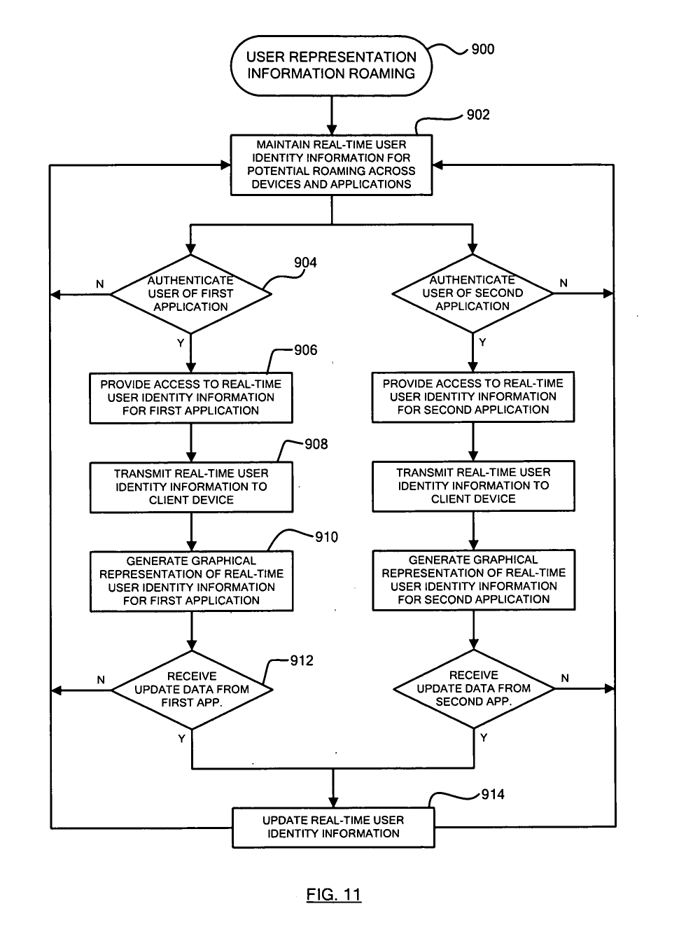

An identity area as described above can be roamed for synchronized rendering on different devices and different collaborative applications using a network server architecture as a centralized location for the user identity information. FIG. 10 is a flow chart of an example process 800 for roaming user representation information in the context of two or more client devices and FIG. 11 is a flow chart of an example process 900 for roaming user representation information in the context of two or more collaborative applications. These two processes are depicted separately for ease of description. In an example embodiment, however, the functionality of the two processes may be combined in a seamless manner.

The various tasks performed in connection with information roaming process 800 and information roaming process 900 may be performed by software, hardware, firmware, or any combination thereof. For illustrative purposes, the following descriptions of these processes may refer to elements mentioned above in connection with FIGS. 1-9. In practical embodiments, portions of process 800 and process 900 may be performed by different elements of the described system. It should be appreciated that process 800 or process 900 may include additional, alternative, or fewer tasks, the tasks shown in FIG. 10 and FIG. 11 need not be performed in the illustrated order, and process 800 and/or process 900 may be incorporated into a more comprehensive procedure or process having additional functionality not described in detail herein.

Referring to FIG. 10, information roaming process 800 assumes that real-time user identity information is maintained (task 802) for potential roaming across client devices and/or across collaborative applications. In practice, task 802 may maintain such user identity information for one or more users of a service that supports collaborative applications that can be hosted by or accessed by client devices. The user identity information may include, without limitation: user presence information or data; username or display name information or data; user image information or data; dynamic user status information or data; personal status message information or data; or the like.

Depending upon the system configuration and settings, an identity area can be displayed (concurrently or otherwise) in connection with multiple client devices. For simplicity, process 800 depicts a scenario where two client devices display a consistent identity area. Before providing access to the real-time user identity information to a first client device, process 800 may authenticate a user of the first client device. If the user is authenticated on the first client device (query task 804), then process 800 may proceed to a task 806 to provide access to the user identity information to the first client device. Otherwise, process 800 may exit or be re-entered at an appropriate point, such as task 802. In example embodiments, process 800 performs a network authentication routine to provide access to the user identity information maintained at the network level. Such access is given to enable the presentation of the identity area on the first client device in the context of one or more collaborative applications. In this example, the user identity information is transmitted (task 808) from the network server architecture to the first client device for appropriate handling and processing. In alternate embodiments, the user identity information may be transmitted from the network server architecture to the first client device in conjunction with an HTML or other file.

Eventually the first client device will generate (task 810) a first graphical representation of the user identity information (i.e., a first identity area). The first identity area is therefore rendered in response to the real-time user identity information maintained by the network server architecture. The user of the first client device may be able to modify, add, delete, update, or otherwise change the current user identity information via, for example, one or more of the mechanisms described above in the context of FIG. 7 and FIG. 8. In this regard, the first client device may generate update data that is indicative of a change in the current user identity status and/or a change in the displayed characteristics of the identity area. Accordingly, if the network server architecture receives update data from the first device (query task 812), then information roaming process 800 may perform a task 814 to update the maintained real-time user identity information. The updating of the user identity information will be responsive to the received update data, and the updated user identity status may propagate through the system for rendering on other client devices utilized by the user and other client devices utilized by other network users. If query task 812 does not detect any update data, then process 800 may exit or be re-entered at an appropriate point, such as task 802.

The right “branch” depicted in FIG. 10 is similar to the left “branch” depicted in FIG. 10. The right branch, however, corresponds to a second client device that is distinct from the first client device. Again, the two branches depicted in FIG. 10 may (but need not) represent concurrent processing. In other words, it is possible to have a single user identity concurrently logged in to two different devices, and information roaming process 800 can accommodate such concurrent use.

Referring to FIG. 11, certain tasks in information roaming process 900 may be similar or identical to counterpart tasks in information roaming process 800, and such common tasks will not be redundantly described in detail in the context of process 900. Process 900 also assumes that real-time user identity information is maintained (task 902) for potential roaming across client devices and/or across collaborative applications.

Depending upon the system configuration and settings, an identity area can be displayed (concurrently or otherwise) in connection with multiple applications on a single client device, where those applications are supported by the particular network service. For simplicity, information roaming process 900 depicts a scenario where one client device supports a consistent identity area across two applications. Before providing access to the real-time user identity information, process 900 may authenticate a user of the first application. If the user is authenticated for the first application (query task 904), then process 900 may proceed to a task 906 to provide access to the user identity information for the first application. Otherwise, process 900 may exit or be re-entered at an appropriate point, such as task 902. In example embodiments, process 900 provides authorized access to the user identity information maintained at the network level to enable the presentation of the identity area on the client device in the context of the first application. In this example, the user identity information is transmitted (task 908) from the network server architecture to the client device for appropriate handling and processing. In alternate embodiments, the user identity information may be transmitted from the network server architecture to the first client device in conjunction with an HTML or other file.

Eventually the client device will generate (task 910) a first graphical representation of the user identity information for the first application. The user of the first application may be able to modify, add, delete, update, or otherwise change the current user identity information via, for example, one or more of the mechanisms described above in the context of FIG. 7 and FIG. 8. Thus, the client device may generate update data that is responsive to user interaction with the first application, where the update data is indicative of a change in the current user identity status and/or a change in the displayed characteristics of the identity area. Accordingly, if the network server architecture receives update data from the client device (query task 912), then information roaming process 900 may perform a task 914 to update the maintained real-time user identity information. The updating of the user identity information will be responsive to the received update data, and the updated user identity status may propagate through the system for rendering on other client devices utilized by the user and other client devices utilized by other network users. If query task 912 does not detect any update data, then process 900 may exit or be re-entered at an appropriate point, such as task 902.

The right “branch” depicted in FIG. 11 is similar to the left “branch” depicted in FIG. 11. The right branch, however, corresponds to a second collaborative application that is also supported by the client device. Again, the two branches depicted in FIG. 11 may (but need not) represent concurrent processing. In other words, it is possible to have a single user concurrently running two different collaborative applications on a single client device, and information roaming process 900 can accommodate such concurrent use.

While at least one example embodiment has been presented in the foregoing detailed description, it should be appreciated that a vast number of variations exist. It should also be appreciated that the example embodiment or embodiments described herein are not intended to limit the scope, applicability, or configuration of the systems, methods, or devices in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of roaming consistent user representation information, the method comprising:
maintaining real-time user identity information for users of a service that supports a collaborative application;
providing access to the real-time user identity information to a first client device for presentation of the real-time user identity information in the context of the collaborative application; and
providing access to the real-time user identity information to a second client device for presentation of the real-time user identity information in the context of the collaborative application.

2. A method according to claim 1, wherein maintaining the real-time user identity information comprises maintaining user presence information.

3. A method according to claim 1, wherein maintaining the real-time user identity information comprises maintaining personal status message information.

4. A method according to claim 1, wherein maintaining the real-time user identity information comprises maintaining username information.

5. A method according to claim 1, wherein maintaining the real-time user identity information comprises maintaining user image information.

6. A method according to claim 1, wherein maintaining the real-time user identity information comprises maintaining dynamic user status information.

7. A method according to claim 1, further comprising:
authenticating a user for the first client device before providing access to the real-time user identity information to the first client device; and
authenticating the user for the second client device before providing access to the real-time user identity information to the second client device.

8. A method according to claim 1, further comprising:
receiving, from the first client device or the second client device, update data indicative of a change in a current user identity status; and
updating the real-time user identity information in response to the update data.

9. A method of roaming consistent user representation information, the method comprising:
maintaining real-time user identity information for users of a service that supports at least one collaborative application;
providing access to the real-time user identity information to a client device for presentation of a first graphical representation of the real-time user identity information in the context of a first collaborative application supported by the service; and
providing access to the real-time user identity information to the client device for presentation of a second graphical representation of the real-time user identity information in the context of a second collaborative application supported by the service.

10. A method according to claim 9, wherein maintaining the real-time user identity information comprises maintaining user presence information.

11. A method according to claim 9, further comprising authenticating a user for the service before providing access to the real-time user identity information.

12. A method according to claim 9, further comprising authenticating a user of the first collaborative application before providing access to the real-time user identity information for presentation of the first graphical representation.

13. A method according to claim 9, further comprising authenticating a user of the second collaborative application before providing access to the real-time user identity information for presentation of the second graphical representation.

14. A method according to claim 9, further comprising:
receiving, from the client device, update data indicative of a change in a current user identity status; and
updating the real-time user identity information in response to the update data.

15. A method according to claim 14, wherein the receiving step comprises receiving the update data in response to user interaction with the first collaborative application.

16. A method according to claim 14, wherein the receiving step comprises receiving the update data in response to user interaction with the second collaborative application.

17. A system for roaming consistent user representation information, the system comprising:
a memory element configured to maintain real-time user identity information for users of a service that supports at least one collaborative application; and
an identity information manager coupled to the memory element and configured to provide access to the real-time user identity information to at least one client device for graphical rendering of the real-time user identity information in the context of at least one collaborative application hosted by the at least one client device.

18. A system according to claim 17, further comprising a communication interface coupled to the memory element and configured to transmit the real-time user identity information to the at least one client device.

19. A system according to claim 17, wherein:
the memory element and the identity information manager are realized in a network server architecture;
the system further comprises a first client device configured to receive the real-time user identity information from the network server architecture, and configured to present the real-time user identity information for a collaborative application hosted by the first device; and
the system further comprises a second client device configured to receive the real-time user identity information from the network server architecture, and configured to present the real-time user identity information for a collaborative application hosted by the second device.

20. A system according to claim 17, wherein:
the memory element and the identity information manager are realized in a network server architecture; and
the system further comprises a client device configured to receive the real-time user identity information from the network server architecture, to generate a first graphical representation of the real-time user identity information for a first collaborative application hosted by the client device, and to generate a second graphical representation of the real-time user identity information for a second collaborative application hosted by the client device.
